(19) United States
(12) Patent Application Publication
(10) Pub. No.: US 2011/0284719 A1
(43) Pub. Date: Nov. 24, 2011

(54) ANCHOR FOR A STRING LINE OR THE LIKE

(75) Inventor: Marjan Krnjaic, Patterson Lakes (AU)

(73) Assignee: BOWTIGHT PTY LTD., Patterson Lakes (AU)

(21) Appl. No.: 13/186,559

(22) Filed: Jul. 20, 2011

Related U.S. Application Data
(63) Continuation-in-part of application No. PCT/AU2010/000060, filed on Jan. 22, 2010.

(30) Foreign Application Priority Data
Jan. 22, 2009 (AU) 2009900214

(51) Int. Cl. F16M 13/02; F16M 13/00

(52) U.S. Cl. 248/634

(57) ABSTRACT

An anchor (1) has a body portion (2), a curved portion (3) and a clamping portion (4). The anchor (1) is particularly suited to positioning a string line or the like. The curved portion (3) acts to maintain tension in the string line. The clamping portion (4) acts to readily detachably connect the anchor to a stationary object (24) to facilitate correct positioning of the string line.

### PRIORITY

This application is a continuation-in-part of International Patent Application No. PCT/AU2010/000060, filed Jan. 22, 2010, which claims priority to Australian Provisional Patent No. 2009900214, filed Jan. 22, 2009. The disclosures of those applications are incorporated by reference herein.

### FIELD OF THE INVENTION

The present invention relates to string lines or the like and in particular to anchors which are particularly suitable for anchoring string lines to substantially stationary objects.

### BACKGROUND OF THE INVENTION

String lines are conventionally used, among other purposes, for establishing straight reference lines during building construction, earthworks and the like. The predominant use of such string lines is to establish a straight horizontal reference line or reference level. It is accordingly necessary that, during use, the string line be under tension to minimize sagging caused by its own weight. It is also desirable that such string lines be relatively easy to set up at the required height and that they be at least to some extent able to recover from movement from the set-up position, such as is caused by an accidental knock from a worker or work-tool.

The most common method of mounting and securing a level string line is by incorporating some type of a holding loop or retaining knot on either end of a string and the loop or knot is then used to attach each end of the length of the line to a stationary object. The line is normally attached at both ends to single or multiple fixed objects such as garden stakes, posts, poles or beams. These objects which are used for anchoring have a wide variety of shapes, dimensions, and material type and usually are in a fixed position. Currently to set up a level string line one or both ends of the string must be adjusted manually in the vertical dimension. This is time consuming and normally involves numerous and repetitive tying and untying of knots until set level and desired heights are achieved. Also, if the string line is knocked, pulled or snagged by accident, the string line may either be moved from its original level position or may sag, requiring repetition of the set-up procedure.

### SUMMARY OF THE INVENTION

In contrast, in one aspect, embodiments of the present invention provide an anchor for readily detachably anchoring a string line or the like to an object, the anchor comprising:
a clamping portion which is adapted for readily detachably clamping the anchor to the object; and
a resilient portion which is adapted to apply tension to the string line when the resilient portion is displaced away from an equilibrium position in a direction which is away from the object.

It is preferred that the clamping portion and the resilient portion are both connected to a body portion.

It is preferred that the resilient portion and the body portion are integrally formed. It is further preferred that the resilient portion and the body portion are integrally formed from 20% glass-filled polypropylene.

It is preferred that the resilient portion is curved so as to present a substantially concave-shaped side in the direction of the object.

It is preferred that an end of the resilient portion which is remote from the body portion is slotted to receive the string line or the like.

It is preferred that the body portion has in it a groove which is adapted to receive an edge of a wall of a star picket or the like.

It is preferred that the resilient portion, and the body portion are integrally formed. It is further preferred that the clamping portion, the resilient portion, and the body portion are integrally formed from 20% glass-filled polypropylene.

It is preferred that the clamping portion comprises two straps each of which extend in a different direction which is:
away from the resilient portion; but towards the object.

It is preferred that one end of each of the two straps is integrally formed with the body portion.

It is preferred that each of the two straps comprises a set of projections which are orientated in opposite directions to enable interlocking of two straps by interengaging sets of projections.

Alternatively, it is preferred that the clamping portion comprises hook-and-loop material. It is further preferred that the clamping portion comprises a tape which carries the hook-and-loop material. In this case, it is preferred that the tape is threaded through a channel which passes through the body portion.

In another aspect, embodiments of the present invention provide an anchor for readily detachably anchoring a string line or the like to an object, the anchor comprising:
a body portion having a channel through it, the channel being adapted to receive a hook-and-loop fastener which is adapted for readily detachably clamping the anchor to the object; and
a resilient portion which is adapted to apply tension to the string line when the resilient portion is displaced away from an equilibrium position in a direction which is away from the object.

It is preferred that the resilient portion and the body portion are integrally formed.

It is preferred that the resilient portion and the body portion are integrally formed from 20% glass-filled polypropylene.

It is preferred that the resilient portion is curved so as to present a substantially concave-shaped side in the direction of the object.

It is preferred that an end of the resilient portion which is remote from the body portion is slotted to receive the string line or the like.

It is preferred that the body portion has in it a groove which is adapted to receive an edge of a wall of a star picket or the like.

### BRIEF DESCRIPTION OF THE DRAWINGS

For a better understanding of the invention, and to show how it may be carried into effect, preferred embodiments of it are shown, by way of non-limiting example only, in the accompanying drawings. In the drawings:

FIG. 1 is a plan view of a preferred embodiment of the invention;

FIG. 2 is a front elevational view of the embodiment of FIG. 1;

FIG. 3 is side elevational view of the embodiment of FIG. 1;

FIG. 4 is a cross-sectional view, partly in elevation, on the line D-D of FIG. 3;

FIG. 5 is an isometric view of the embodiment of FIG. 1;

FIG. 6 is a plan view illustrating a method of mounting the embodiment of FIG. 1 to a star picket or the like; and

FIGS. 7 and 8 illustrate adjustment of the positioning of the embodiment of FIG. 1 on a stake or the like;

FIG. 9 is an isometric view from one direction of another preferred embodiment of the invention;

FIG. 10 is an isometric view from another direction of the embodiment of FIG. 9;

FIGS. 11, 12 and 13 are side elevational views of the embodiment of FIG. 9;

FIG. 14 is a plan view of the embodiment of FIG. 9; and

FIG. 15 is a plan view illustrating a method of mounting the embodiment of FIG. 9 to a star picket or the like.

### DESCRIPTION OF PREFERRED EMBODIMENTS OF THE INVENTION

### Structure of a First Preferred Embodiment

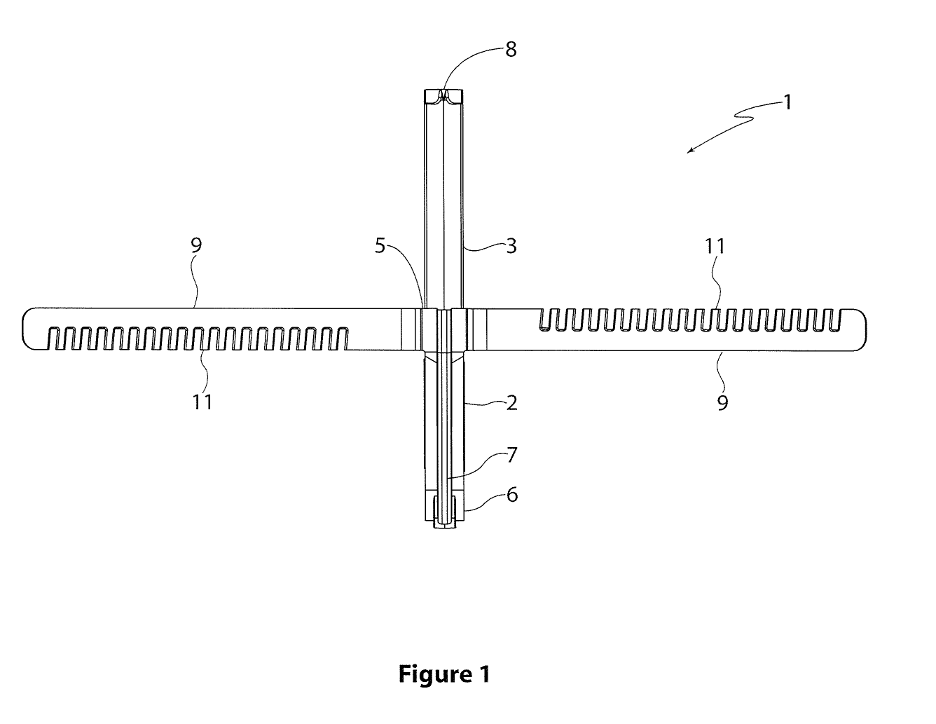

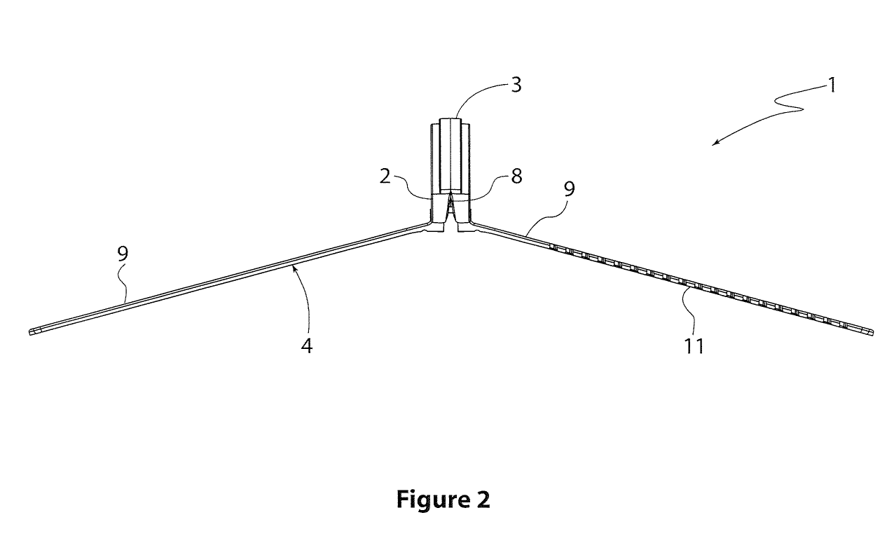

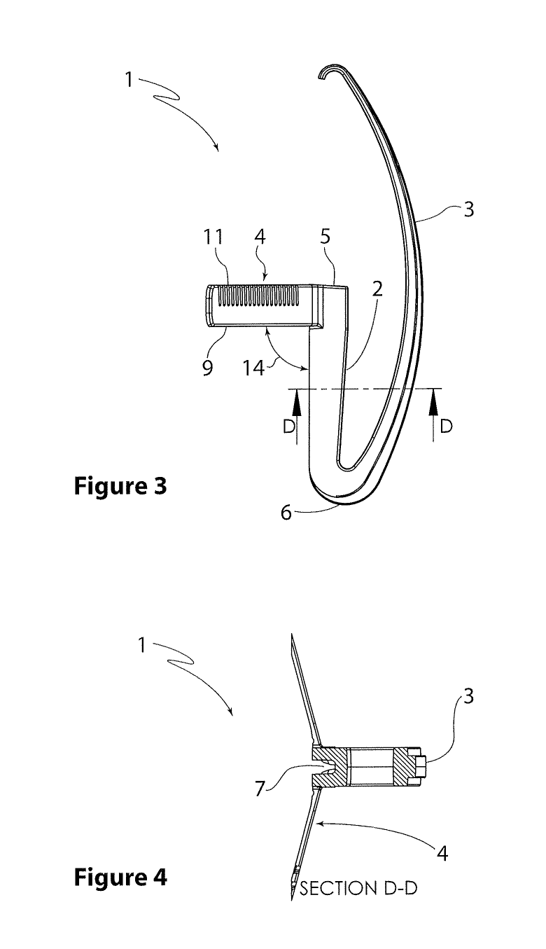

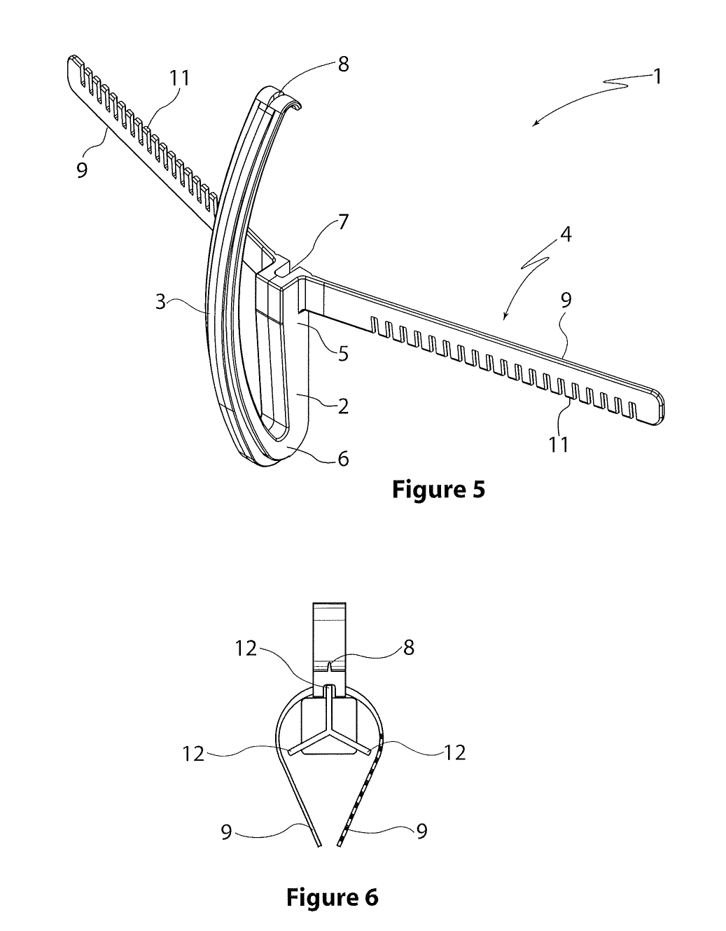

The anchor 1 according to a first preferred embodiment of the invention illustrated in FIGS. 1 to 8 of the drawings. According to this embodiment, the anchor 1 is integrally formed and comprises a body portion 2, a curved portion 3 and a clamping portion 4. The body portion 2 and the curved portion 3 merge into each other in a tail region 6. The body portion 2 and the clamping portion 4 merge in a region 5 which is remote from the tail region 6.

The body portion 2 comprises a longitudinally-running slot 7 which is adapted to receive an edge 12 of a wall of a star picket 13 or the like as is illustrated in FIG. 6.

The orientation of curved portion 3 is such that it is substantially co-planar with the body portion 2. The concave side of the curved portion 3 faces towards the body portion 2. A substantially V-shaped notch 8 is formed in the end of the curved portion 3 which is remote from the tail region 6. The curved portion 3 tapers along its length from the tail region 6 and includes an external rib 16. The tapering of the curved portion 3 and the external rib 16 are provided with a view to reducing the amount of material used in manufacture while achieving maximum strengthening of the portion 3 within the limitations imposed by the moulding technique which is used in manufacture.

The clamping portion 4 comprises two straps 9. Each strap 9 extends away from the portion 5 at an angle which is acute to the plane which is common to the body portion 2 and the curved portion 3, so that the straps 9 in plan view form a broad “V” shape. Each strap 9 comprises a series of finger-like or saw-tooth like projections 11. Each series of projections 11 are orientated in opposite directions to enable interlocking of the two straps by interengaging the two sets of projections.

The region of the wall of the body portion 2 which is proximate the clamping portion 4 makes an angle 14 which is slightly less than 90° to the plane in which the straps 9 lie.

### Manufacture of The First Preferred Embodiment

The anchor 1 is formed in any suitable manner from any suitable material. Suitable materials include plastics, metals, and a combination of both plastics and metals. At least the curved portion 3 of the anchor 1 is formed from a resilient material, such that when any deflection force is applied to that portion will generate a countervailing to bias it back towards its equilibrium position. A preferred form of manufacture is by moulding in plastics material. A preferred material is 20% glass-filled polypropylene.

### Use of the First Preferred Embodiment

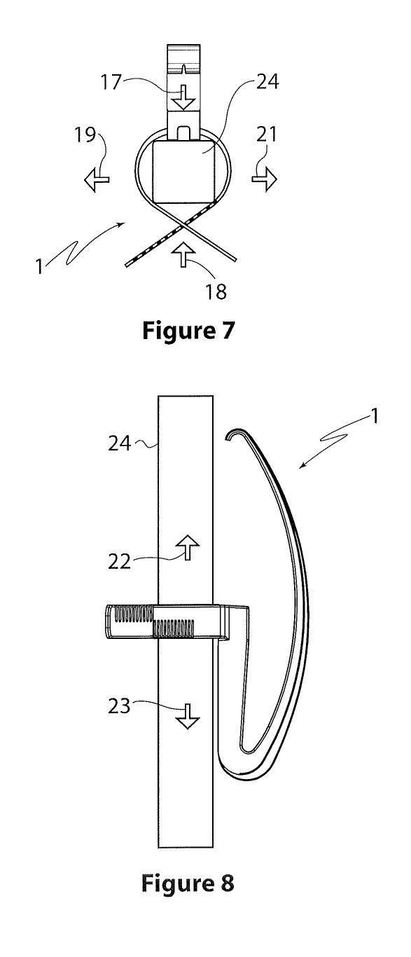

According to the preferred method of use, a string line is anchored at each end by attachment to a separate anchor 1. The string line is preferably attached to an anchor by threading the line into the V-slot 8 at the tip of the curved portion 4 and winding the line in a figure-8 configuration about the arms of the V-slot. As is illustrated in FIGS. 6 and 7, the body portion 2 of each anchor 1 is placed against with a relatively stationary object and the two straps 9 are wrapped around the object under some tension and the projections 11 are interengaged to clamp the anchor 1 to the object. When the anchor 1 is clamped to an object such as a straight pipe, because the angle 14 is slightly less than 90°, resilience of the body portion 2 results in pre-loading of the clamping mechanism.

FIGS. 7 and 8 illustrate a method of adjusting the vertical positioning of an anchor 1 on a stake or the like 24. As is illustrated in FIG. 7, the application of compressive force (for example, by use of the thumb and opposed fingers) in the directions of arrows 17 and 18 results in some movement or expansion of the straps 9 away from the stake or the like 24 in the directions of the arrows 19 and 21. This movement or expansion of the straps 9 results in a loosening of the fit between the anchor 1 and the stake or the like 24, facilitating movement of the anchor 1 in the directions of arrows 22 or 23 of FIG. 8, in turn facilitating adjustment of the position of the anchor 1. On release of the compressive force, the straps 9 “contract” back towards the stake or the like 24, tightening the fit with the stake or the like 24.

The string line stretches between the two anchors 1 under tension which is generated by the resilience of each of the curved portions 1. The clamping portion 4 functions to readily-detachably connect an anchor to an object, avoiding the necessity for tying and untying knots or the like when performing the process of positioning the string line to, for example, achieve true horizontal orientation at the desired vertical position.

### Structure of a Second Preferred Embodiment

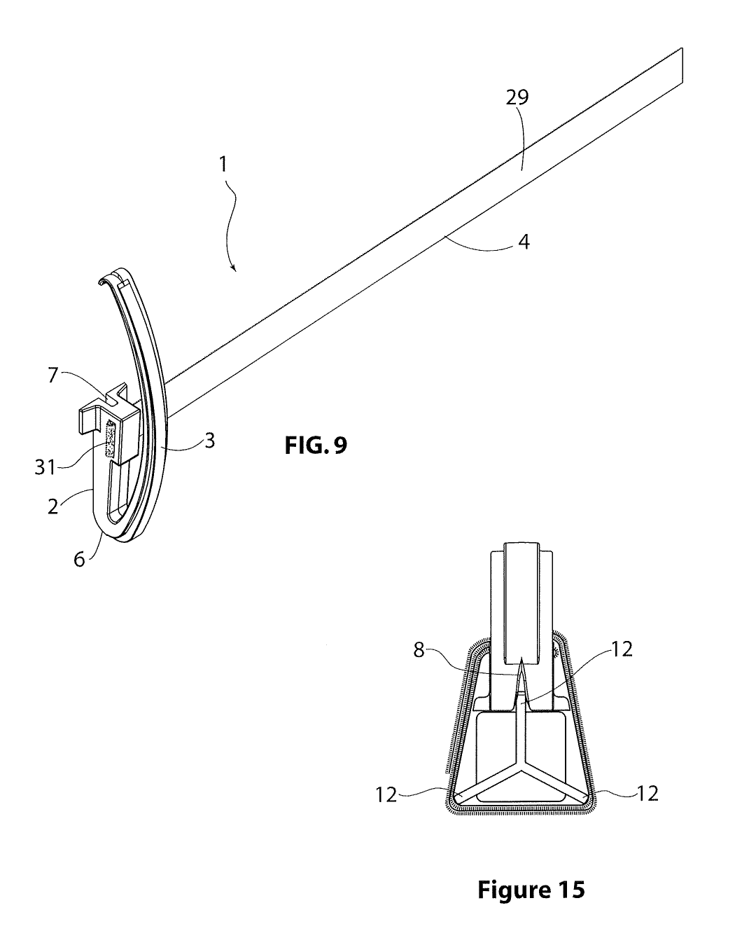

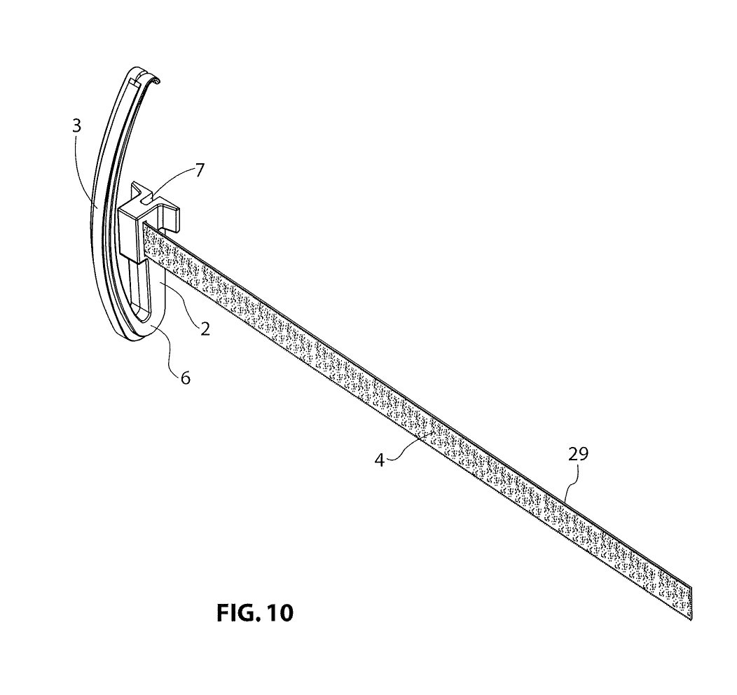

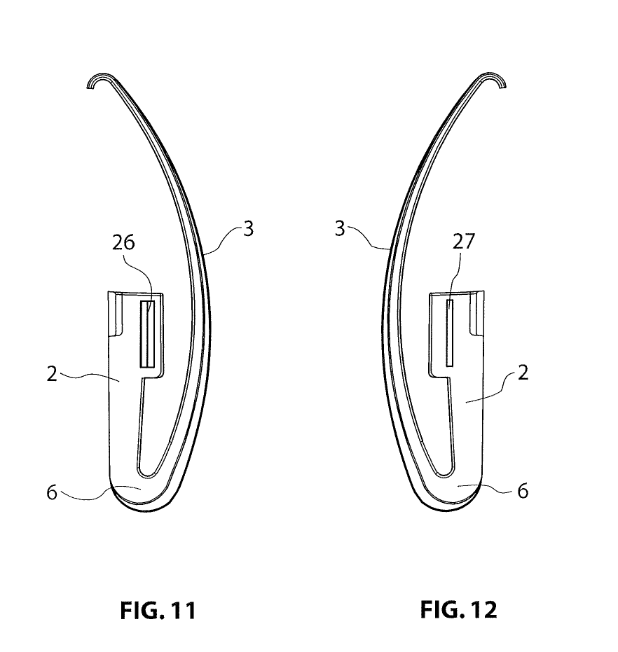

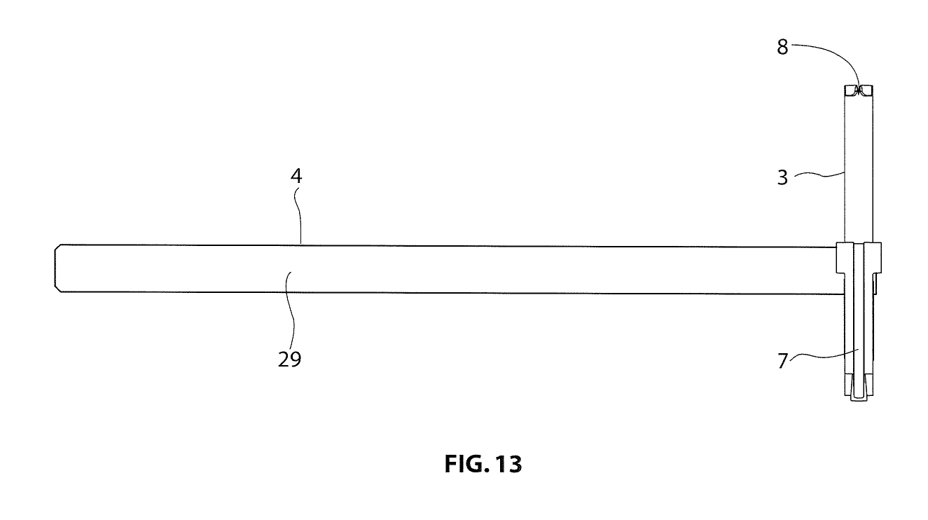

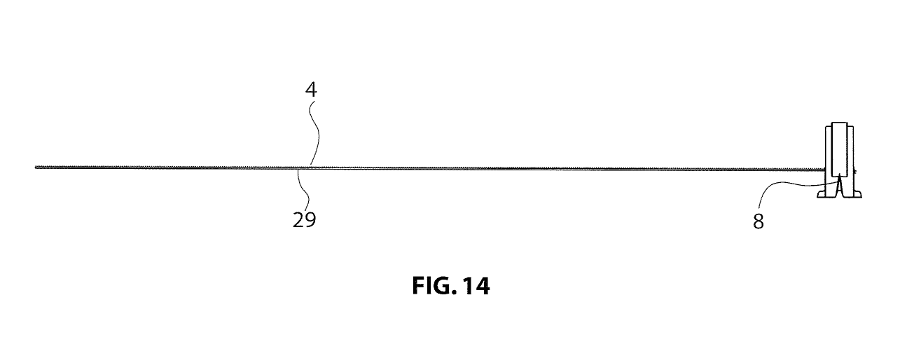

The anchor 1 according to a second preferred embodiment of the invention illustrated in FIGS. 9 to 15 of the drawings. FIGS. 9 to 15 use the same reference numbers as do FIGS. 1 to 8 to refer to like parts of the two preferred embodiments. According to the embodiment of FIGS. 9 to 15, the anchor 1 comprises a body portion 2 which is integrally formed with a curved portion 3, and a separately-formed clamping portion 4. The body portion 2 and the curved portion 3 merge into each other in a tail region 6. As is illustrated in FIGS. 11 and 12, the body portion 2 has a tapered channel through it, so that the aperture 26 on one side of the body portion 2 is larger than is the aperture 27 on the opposite side of the body portion 2. As is best illustrated in FIGS. 9 and 10, the clamping portion 4 comprises a hook-and-loop tape 29 which is threaded through the body portion 2 in the direction from aperture 26 to aperture 27. As is illustrated in FIG. 9, an end portion of the hook-and-loop tape 29 is folded over and fastened to form a structure which wedges within the tapered channel through the body portion 2. The hook-and-loop tape 29 is preferably injection moulded from plastics material which is substantially composed of polypropylene and which has fabric glued to one side of it. The construction and manufacture of this second preferred embodiment of the invention is otherwise the same as is the construction of the previously-described embodiment of the invention.

As is illustrated in FIG. 15, the anchor 1 according to the second preferred embodiment of the invention is fixed in place by placing the body portion 2 against a relatively stationary object and the hook-and-loop tape 29 is wrapped around that object and around the body portion 2.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

Throughout this specification, the words “comprise”, “comprising” and “comprises” are to be taken to specify the presence of stated features, integers, steps or components but does not preclude the presence or addition of one or more other features, integers, steps, components or groups thereof.

In the claims, each dependent claim is to be read as being within the scope of its parent claim or claims, in the sense that a dependent claim is not to be interpreted as infringed unless its parent claims are also infringed.

1. An anchor for readily detachably anchoring a string line or the like to an object, the anchor comprising:
a clamping portion which is adapted for readily detachably clamping the anchor to the object; and
a resilient portion which is adapted to apply tension to the string line when the resilient portion is displaced away from an equilibrium position in a direction which is away from the object.

2. An anchor for readily detachably anchoring a string line or the like to an object as claimed in claim 1, in which the clamping portion and the resilient portion are both connected to a body portion.

3. An anchor for readily detachably anchoring a string line or the like to an object as claimed in claim 2, in which the resilient portion and the body portion are integrally formed.

4. An anchor for readily detachably anchoring a string line or the like to an object as claimed in claim 3, in which the resilient portion and the body portion are integrally formed from 20% glass-filled polypropylene.

5. An anchor for readily detachably anchoring a string line or the like to an object as claimed in claim 2, in which the resilient portion is curved so as to present a substantially concave-shaped side in the direction of the object.

6. An anchor for readily detachably anchoring a string line or the like to an object as claimed in claim 2 in which an end of the resilient portion which is remote from the body portion is slotted to receive the string line or the like.

7. An anchor for readily detachably anchoring a string line or the like to an object as claimed in claim 2 in which the body portion has in it a groove which is adapted to receive an edge of a wall of a star picket or the like.

8. An anchor for readily detachably anchoring a string line or the like to an object as claimed in claim 3 in which the clamping portion, the resilient portion, and the body portion are integrally formed.

9. An anchor for readily detachably anchoring a string line or the like to an object as claimed in claim 8 in which the clamping portion, the resilient portion, and the body portion are integrally formed from 20% glass-filled polypropylene.

10. An anchor for readily detachably anchoring a string line or the like to an object as claimed in claim 8 in which the clamping portion comprises two straps each of which extend in a different direction which is:
away from the resilient portion; but towards the object.

11. An anchor for readily detachably anchoring a string line or the like to an object as claimed in claim 10 in which one end of each of the two straps is integrally formed with the body portion.

12. An anchor for readily detachably anchoring a string line or the like to an object as claimed in claim 10 which each of the two straps comprises a set of projections which are orientated in opposite directions to enable interlocking of two straps by interengaging sets of projections.

13. An anchor for readily detachably anchoring a string line or the like to an object as claimed in claim 3 in which the clamping portion comprises hook-and-loop material.

14. An anchor for readily detachably anchoring a string line or the like to an object as claimed in claim 13 in which the clamping portion comprises a tape which carries the hook-and-loop material.

15. An anchor for readily detachably anchoring a string line or the like to an object as claimed in claim 14 in which the tape is threaded through a channel which passes through the body portion.

16. An anchor for readily detachably anchoring a string line or the like to an object, the anchor comprising:
a body portion having a channel through it, the channel being adapted to receive a hook-and-loop fastener which is adapted for readily detachably clamping the anchor to the object; and
a resilient portion which is adapted to apply tension to the string line when the resilient portion is displaced away from an equilibrium position in a direction which is away from the object.

17. An anchor for readily detachably anchoring a string line or the like to an object as claimed in claim 16, in which the resilient portion and the body portion are integrally formed.

18. An anchor for readily detachably anchoring a string line or the like to an object as claimed in claim 17, in which the resilient portion and the body portion are integrally formed from 20% glass-filled polypropylene.

19. An anchor for readily detachably anchoring a string line or the like to an object as claimed in claim 16 in which the resilient portion is curved so as to present a substantially concave-shaped side in the direction of the object.

20. An anchor for readily detachably anchoring a string line or the like to an object as claimed in claim 16 in which an end of the resilient portion which is remote from the body portion is slotted to receive the string line or the like.

21. An anchor for readily detachably anchoring a string line or the like to an object as claimed in claim 16 in which the body portion has in it a groove which is adapted to receive an edge of a wall of a star picket or the like.
